(19) United States
(12) Patent Application Publication
(10) Pub. No.: US 2026/0317994 A1
(43) Pub. Date: Oct. 15, 2026

(54) AEROGEL COMPOSITE MATERIAL AND METHOD OF MANUFACTURING AEROGEL COMPOSITE MATERIAL

(71) Applicant: Owens Corning Intellectual Capital, LLC, Toledo, OH (US)

(72) Inventors: Hongze LI, Hangzhou, Zhejiang (CN); Zheng LI, Hangzhou, Zhejiang (CN); Qiuxia YU, Hangzhou, Zhejiang (CN); Wenbin QUE

(21) Appl. No.: 19/113,055

(22) PCT Filed: Aug. 14, 2024
(86) PCT No.: PCT/US2024/042206

§ 371 Date: Mar. 19, 2025

(30) Foreign Application Priority Data
Sep. 7, 2023 (CN) 202311152915.X

(51) Int. Cl. D06M 10/06; C09D 1/00; C09D 5/03; D06M 101/16; D06M 101/20

(52) U.S. Cl. CPC D06M 10/06; C09D 1/00; C09D 5/031; D06M 2101/16; D06M 2101/20

(57) ABSTRACT

The present invention discloses an aerogel composite material and a preparation method thereof. The aerogel composite material comprises a porous fiber material and an aerogel powder distributed within the porous fiber material. The aerogel powder is impregnated into the porous fiber material by applying an alternating electric field to the porous fiber material. The aerogel powder is impregnated into the porous fiber materials by the alternating electric field. The aerogel powder has a large impregnation amount and is uniform such that the aerogel composite material has better thermal insulation properties, with simple process and low production cost.

### CROSS-REFERENCE TO RELATED APPLICATION(S)

This application claims priority to Chinese Patent Application No. 202311152915.X filed on Sep. 7, 2023, the disclosure of which is incorporated by reference herein in its entirety.

### BACKGROUND

The present invention relates to the technical field of aerogel, and in particular to an aerogel composite material and a method of manufacturing an aerogel composite material.

Aerogel composite material is a new advanced material, which is made by the combination of nano-aerogel particles and fiber materials through a special process. It has the characteristics of light weight, heat insulation with high efficiency, fire prevention and environmental protection, and is widely used in construction, petroleum, aerospace and other fields.

At present, aerogel composite material is mainly manufactured by a supercritical drying method. The supercritical drying method is to replace the solvent in the sol-gel pre-impregnated in the fiber material by using the special properties of supercritical fluid (such as carbon dioxide), so as to achieve the transformation of sol-gel to aerogel, and make the aerogel grow in situ in the fiber material. Aerogel composite materials (such as Chinese patents CN100540257C, CN105906298A) are manufactured. The supercritical drying method requires supercritical conditions. The cost of supercritical drying equipment is large, the process operation is complicated, the process energy consumption is very high, and the selection for precursor has certain restrictions.

In addition to the supercritical drying method, some technologies have successively realized the production of aerogel by an atmospheric pressure drying method, which converts sol-gel into aerogel under atmospheric pressure at room temperature or atmospheric pressure at high temperature by doing a large amount of hydrophobic modification in advance (such as Chinese patents CN103771428A, CN109806817A). The atmospheric pressure drying method has low equipment cost and low energy consumption. However, the limitation on further industrialization of the atmospheric pressure drying method is that it can only produce aerogel powder on a large scale, and cannot prepare aerogel composite materials in situ.

In recent years, many studies have focused on the preparation of aerogel composite materials by the special process of recompounding aerogel powder prepared by the atmospheric pressure drying method into the fiber felt. The most common technical means is to configure the aerogel powder into an aerogel slurry, compound it into the fiber material by impregnation, and then volatilize the solvent (such as Chinese patents CN112301732B and CN114835435A). However, in the process of configuring the slurry, the aerogel nanopore structure will be damaged and cause performance loss, and the whole process needs to use a lot of solvents and drying equipments, whose cost is large and energy consumption is high. There are also some technical means to avoid the use of solvents, with which the aerogel powder is spread on the fiber felt manually or by electrostatic spraying, and the composite is carried out by acupuncture process (CN115874348B). However, the dispersion of aerogel powder in fiber materials is always poor, and it cannot reach the good uniformity of aerogel composite materials prepared by the supercritical drying method.

The use of secondary composite of the aerogel powder to prepare aerogel composite materials will greatly reduce the production cost of aerogel materials and expand its application in industrial production, but the limitation of composite technology hinders its development.

To provide a secondary composite technology with low process input cost, low production energy consumption, simple preparation process, excellent distribution effect of aerogel powder and good pore structure and properties is an urgent technical problem that needs to be solved in this field.

### SUMMARY

A series of simplified concepts is introduced into the portion of Summary, which would be further illustrated in the portion of the detailed description. The Summary of the present invention does not mean attempting to define the key feature and essential technical feature of the claimed technical solution, let alone determining the protection scope thereof.

The present invention provides an aerogel composite material, comprising: a porous fiber material; an aerogel powder distributed in the porous fiber material, wherein the aerogel powder is impregnated in the porous fiber material by applying an alternating electric field to the porous fiber material, wherein a density of the aerogel powder ranges from 0.01 g/cm³ to 0.5 g/cm³, and an average particle size of the aerogel powder is less than or equal to 500 μm.

In a specific embodiment, a voltage of the alternating electric field ranges from 0.1 KV to 50 KV, and a frequency ranges from 1 HZ to 800 HZ; an application time of the alternating electric field ranges from 30 seconds to 5 minutes.

In a specific embodiment, a density of the aerogel powder ranges from 0.03 g/cm³ to 0.1 g/cm³, and an average particle size of the aerogel powder is less than or equal to 50 μm.

In a specific embodiment, the porous fiber material is selected from a glass fiber felt, a glass fiber non-woven fabric, a glass fiber textile fabric, a ceramic fiber felt, a paper, a polyurethane fiber felt, a carbon fiber felt, a polypropylene fiber felt, a polypropylene, and a glass fiber composite felt, and a combination of the above.

In a specific embodiment, an areal density of the glass fiber non-woven fabric is between 20 g/m² and 500 g/m²; a thickness is between 0.3 mm and 4 mm; and an air permeability is between 200 L/m²/s and 3000 L/m²/s.

In a specific embodiment, an areal density of the glass fiber non-woven fabric is between 50 g/m² and 150 g/m²; a thickness is between 0.5 mm and 1.5 mm; and an air permeability is between 500 L/m²/s and 2000 L/m²/s.

In a specific embodiment, an areal density of the glass fiber non-woven fabric is between 90 g/m² and 135 g/m²; a thickness is between 0.8 mm and 1.3 mm; and an air permeability is between 1100 L/m²/s and 1800 L/m²/s.

In a specific embodiment, the polypropylene and the glass fiber composite felt is made by blending a polypropylene fiber with a glass fiber; a density of the polypropylene and the glass fiber composite felt is between 20 kg/m³ and 200 kg/m³, and a thickness is between 1 mm and 20 mm.

In a specific embodiment, a density of the polypropylene and the glass fiber composite felt is between 50 kg/m³ and 150 kg/m³, and a thickness is between 3 mm and 10 mm.

In a specific embodiment, an additive for inhibiting thermal radiation is added to the aerogel powder, and the additive is selected from at least one of silicon carbide, boron carbide, titanium oxide and boron nitride; a weight ratio of the additive to the aerogel powder ranges from 1 wt % to 15 wt %.

In a specific embodiment, a weight ratio of the additive to the aerogel powder ranges from 5 wt % to 12 wt %.

In a specific embodiment, a weight ratio of the aerogel powder to the aerogel composite material ranges from 1 wt % to 50 wt %.

The present invention further provides a method of manufacturing the aerogel composite material as mentioned above, wherein the method comprises the following steps: impregnating an aerogel powder into a porous fiber material by applying an alternating electric field, wherein a voltage of the alternating electric field ranges from 0.1 KV to 200 KV; a frequency ranges from 0.1 HZ to 800 HZ; a density of the aerogel powder ranges from 0.01 g/cm³ to 0.5 g/cm³; and an average particle size of the aerogel powder is less than or equal to 500 μm.

In a specific embodiment, an application time of the alternating electric field ranges from 30 seconds to 5 minutes.

In a specific embodiment, a step is further comprised to apply the aerogel powder to a surface of the porous fiber material and/or apply the aerogel powder to a loader that is at least partially subject to the alternating electric field.

In a specific embodiment, the porous fiber material and the aerogel powder are arranged between a lower electrode and an upper electrode, and the electrode is electrically insulated from each other through a dielectric and connected to a power supply such that the porous fiber material and the aerogel powder are subject to the alternating electric field.

In a specific embodiment, a density of the aerogel powder ranges from 0.03 g/cm³ to 0.1 g/cm³, and an average particle size of the aerogel powder is less than or equal to 50 μm.

In a specific embodiment, the porous fiber material is selected from a glass fiber felt, a glass fiber non-woven fabric, a glass fiber textile fabric, a ceramic fiber felt, a paper, a polyurethane fiber felt, a carbon fiber felt, a polypropylene fiber felt, a polypropylene, and a glass fiber composite felt, and a combination of the above.

In a specific embodiment, an areal density of the glass fiber non-woven fabric is between 20 g/m² and 500 g/m²; a thickness is between 0.3 mm and 4 mm; and an air permeability is between 200 L/m²/s and 3000 L/m²/s.

In a specific embodiment, an areal density of the glass fiber non-woven fabric is between 50 g/m² and 150 g/m²; a thickness is between 0.5 mm and 1.5 mm; and an air permeability is between 500 L/m²/s and 2000 L/m²/s.

In a specific embodiment, an areal density of the glass fiber non-woven fabric is between 90 g/m² and 135 g/m²; a thickness is between 0.8 mm and 1.3 mm; and an air permeability is between 1100 L/m²/s and 1800 L/m²/s.

In a specific embodiment, the polypropylene and the glass fiber composite felt is made by blending a polypropylene fiber with a glass fiber; a density of the polypropylene and the glass fiber composite felt is between 20 kg/m³ and 200 kg/m³, and a thickness is between 1 mm and 20 mm.

In a specific embodiment, a density of the polypropylene and the glass fiber composite felt is between 50 kg/m³ and 150 kg/m³, and a thickness is between 3 mm and 10 mm.

In a specific embodiment, an additive for inhibiting thermal radiation is added to the aerogel powder, and the additive is selected from at least one of silicon carbide, boron carbide, titanium oxide and boron nitride; a weight ratio of the additive to the aerogel powder ranges from 1 wt % to 15 wt %.

In a specific embodiment, a weight ratio of the additive to the aerogel powder ranges from 5 wt % to 12 wt %.

The present invention provides an aerogel composite material. One of the innovations of the aerogel composite material provided by the invention is that the alternating electric field is applied to the process of preparing the aerogel composite material, so that the aerogel composite material of the invention has more prominent technical advantages compared with the aerogel composite material manufactured by the supercritical drying method or the slurry impregnation method in prior art or other prior arts. For example, compared to the supercritical drying method, there is no need to use a complex supercritical equipment and high energy consumption to produce supercritical fluid, and the aerogel composite material can be manufactured while meeting the requirements for the uniformity of distribution of aerogel powder by only needing to use the aerogel powder prepared by the alternating electric field of a simple structure and atmospheric pressure drying method, with simple manufacturing process, low input cost and low energy consumption. Compared to the aerogel slurry impregnation method, the aerogel composite material has better performance because it does not require solvent impregnation and thereby avoids the destruction of the structure of the aerogel powder. At the same time, the process does not include the use of solvents and drying, which reduces a lot of energy consumption.

In addition, aerogel powder is impregnated into porous fiber materials by alternating electric field, and the aerogel powder has a large impregnation amount and uniform such that the aerogel composite material has better thermal insulation properties. The process is simple, and the production cost is low.

### BRIEF DESCRIPTION OF THE DRAWINGS

The following drawings are hereby incorporated as part of the present invention for the understanding of the present invention. The embodiments are illustrated and described in the drawings in order to explain the principles of the present invention.

In the drawings:

FIG. 1 is a SEM photograph of a vertical cross-section of an aerogel composite material according to Example 1 of the present invention;

FIG. 2a is a SEM photograph of a vertical cross-section of an aerogel composite material according to Example 2 of the present invention;

FIG. 2b is a SEM photograph of a front side of the aerogel composite material according to Example 2 of the present invention;

FIG. 2c is a SEM photograph of a back side of the aerogel composite material according to Example 2 of the present invention;

FIG. 3a is a SEM photograph of a vertical cross-section of an aerogel composite material according to Contrast Example 1 of the present invention;

FIG. 3b is a SEM photograph of a front side of an aerogel composite material according to Contrast Example 1 of the present invention;

FIG. 3c is a SEM photograph of a back side of an aerogel composite material according to Contrast Example 1 of the present invention;

FIG. 4a is a SEM photograph of a vertical cross-section of an aerogel composite material according to Contrast Example 2 of the present invention;

FIG. 4b is a SEM photograph of a front side of an aerogel composite material according to Contrast Example 2 of the present invention; and

FIG. 4c is a SEM photograph of a back side of an aerogel composite material according to Contrast Example 2 of the present invention.

### DETAILED DESCRIPTION

In the following description, numerous specific details are set forth in order to provide a more thorough understanding of the present invention. However, it is obvious to those skilled in this art that the present invention may be implemented without one or more of these details. Some technical features well-known in this art are not described in other examples in order to avoid confusion with the present invention.

In order to thoroughly understand the present invention, a detailed description will be provided in the following description to elaborate the aerogel composite material and the method of manufacturing the aerogel composite material of the present invention. Obviously, the implementation of the present invention is not limited to the specific details familiar to those skilled in the art. The preferred embodiments of the present invention are described in detail as follows. However, in addition to these detailed descriptions, the present invention may have other embodiments.

It shall be noted that the terminology used herein is for the purpose of describing particular embodiments only and is not intended to limit the exemplary embodiments of the present invention. As used herein, the singular forms are intended to include the plural forms as well, unless the context clearly indicates otherwise. It will be further understood that the terms “comprising” and/or “including,” when used in this specification, specify the presence of stated features, wholes, steps, operations, elements, and/or components, but do not preclude the presence or addition of one or more other features, wholes, steps, operations, elements, components, and/or combinations thereof.

The exemplary embodiments according to the present invention will now be described in detail with reference to the drawings. However, these exemplary embodiments can be implemented in various forms but should not be construed as being limited to the embodiments set forth herein. It is to be understood that these embodiments are provided to make the disclosure of the invention thorough and complete, and that the ideas of these exemplary embodiments are fully communicated to those of ordinary skill in the art.

To at least partially solve the problem, a first aspect of the present invention provides an aerogel composite material. One of the innovations of the aerogel composite material provided by the invention is that the alternating electric field is applied to the process of preparing the aerogel composite material, so that the aerogel composite material of the invention has more prominent technical advantages compared with the aerogel composite material manufactured by the supercritical drying method or the slurry impregnation method in prior art or other prior arts. For example, compared to the supercritical drying method, there is no need to use a complex supercritical equipment and high energy consumption to produce supercritical fluid, and the aerogel composite material can be manufactured while meeting the requirements of the uniformity of distribution of aerogel powder by only needing to use the aerogel powder prepared by the alternating electric field with a simple structure and atmospheric pressure drying method, with simple manufacturing process, low input cost and low energy consumption. Compared to the aerogel slurry impregnation method, the aerogel composite material has better performance because it does not require solvent impregnation and thereby avoids the destruction of the structure of the aerogel powder. At the same time, the process does not include the use of solvents and drying, which reduces a lot of energy consumption.

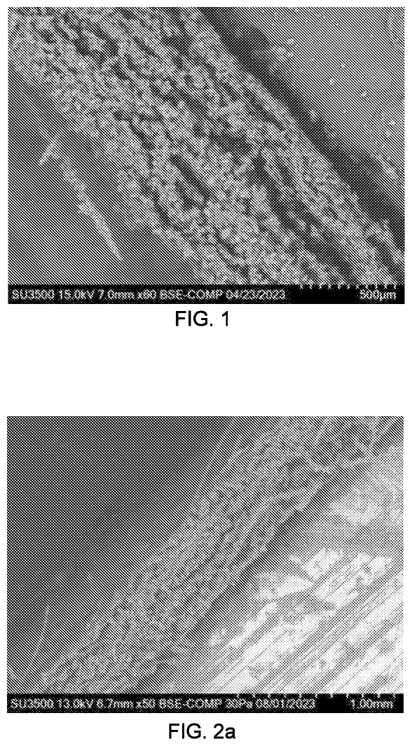

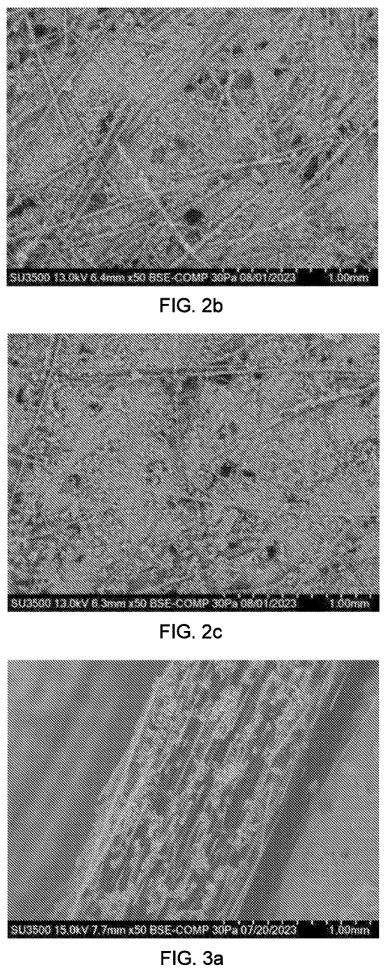

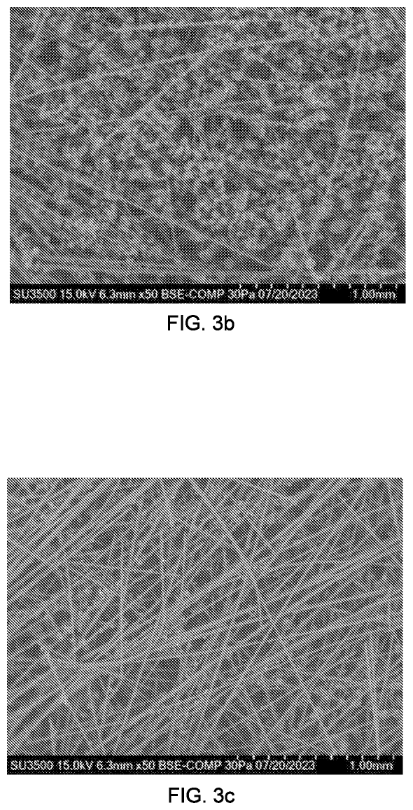

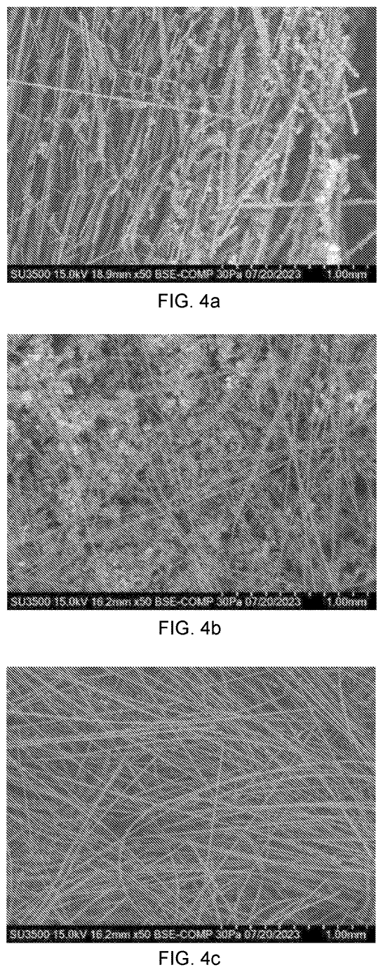

Specifically, the aerogel composite material disclosed in the present invention may include a porous fiber material and an aerogel powder distributed within the porous fiber material. By applying the alternating electric field to the porous fiber material, the aerogel powder is impregnated not only into the porous fiber material, but also is impregnated more uniformly. With reference to FIG. 1 and FIG. 2a, the SEM photographs of the aerogel composite material of Examples 1 and 2 in vertical cross section are shown. Compared to FIG. 3a and FIG. 4a of Contrast Examples, it can be seen that the aerogel powder in the aerogel composite material of the invention is more evenly distributed and has a relatively large amount of impregnation. In multiple embodiments, the weight ratio of the aerogel powder to the aerogel composite material may range from 1 wt % to 50 wt %.

An alternating electric field refers to an electric field whose magnitude and direction change with time. It is produced by an alternating current power supply, in which the charge oscillates sometimes positively and sometimes negatively, causing a change in the electric field. The alternating electric field is characterized by periodic changes, and its frequency describes the rate of change in Hertz (Hz). The voltage range of the alternating electric field of the invention can be 0.1 KV to 50 KV, the frequency range can be 1 HZ to 800 HZ, and the application time of the alternating electric field can be 30 seconds to 5 minutes. Those skilled in the art can adjust any of the above parameters according to the actual needs of use and product conditions in the production process.

The density of the aerogel powder of the aerogel composite material of the present invention can range from 0.01 g/cm³ to 0.5 g/cm³, and the average particle size of the aerogel powder is less than or equal to 500 μm. Preferably, the density of the aerogel powder can range from 0.03 g/cm³ to 0.1 g/cm³, and the average particle size of the aerogel powder is less than or equal to 50 μm. For example, the aerogel powder may be JIOS aerogel Company AeroVa® aerogel powder (Chinese patent CN103771428B and US patent US20220306833 are incorporated by reference as a whole into this specification).

The porous fiber material can be selected from a glass fiber felt, a glass fiber non-woven fabric, a glass fiber textile fabric, a ceramic fiber felt, a paper, a polyurethane fiber felt, a carbon fiber felt, a polypropylene fiber felt, a polypropylene, and a glass fiber composite felt, and a combination of the above. Preferably, the porous fiber material can use the glass fiber non-woven fabric, whose areal density can be between 20 g/m² and 500 g/m², thickness can be between 0.3 mm and 4 mm, and air permeability can be between 200 L/m²/s and 3000 L/m²/s. Further preferably, the areal density can be between 50 g/m² and 150 g/m², the thickness can be between 0.5 mm and 1.5 mm, and the air permeability can be between 500 L/m²/s and 2000 L/m²/s, or the areal density is between 90 g/m² and 135 g/m², the thickness is between 0.8 mm and 1.3 mm, and the air permeability is between 1100 L/m²/s and 1800 L/m²/s.

As another preferred embodiment, the polypropylene and glass fiber composite felt with a density between 50 kg/m³ and 150 kg/m³ and thicknesses between 3 mm and 10 mm may also be selected for the porous fiber material. It should be noted that the present invention is not limited to the varieties of the porous fiber material specifically enumerated, as long as the fibrous material with porosity known to the person skilled in the art or the material equivalent to the porous fiber material that can accommodate the aerogel powder is within the protection scope limited by the invention.

In order to improve the thermal insulation and insulation properties of aerogel composite materials, an additive for inhibiting thermal radiation can also be added to the aerogel powder. For example, the additive may be selected from at least one of silicon carbide, boron carbide, titanium oxide and boron nitride. The weight ratio of the additive to the aerogel powder may range from 1 wt % to 15 wt %. Preferably, the weight ratio of the additive to the aerogel powder ranges from 5 wt % to 12 wt %.

A second aspect of the present invention further provides a method of manufacturing the aerogel composite material, wherein the method may fundamentally comprise the following steps:
Feeding: The aerogel powder is applied to the surface of the porous fiber material and/or onto a loader that is at least partially subject to an alternating electric field. For example, the loader may be a conveyor belt or a rotary feeder, or the like. The conveyor belt may be located above the porous fiber material and at least partially located in the alternating electric field. The aerogel powder may be transported through the conveyor belt, and the aerogel powder located on the conveyor belt may be impregnated into the porous fiber material when the alternating electric field is applied.
Treatment: The aerogel powder is impregnated into the porous fiber material by applying an alternating electric field, where the voltage range of the alternating electric field can be 0.1 KV to 200 KV, and the frequency ranges from 0.1 HZ to 800 HZ; the density of the aerogel powder ranges from 0.01 g/cm³ to 0.5 g/cm³, and the average particle size of the aerogel powder is less than or equal to 500 μm. The application time of the alternating electric field ranges from 30 seconds to 5 minutes.

In an optional embodiment, the porous fiber material and the aerogel powder are arranged between a lower electrode and an upper electrode, and the electrodes are electrically insulated from each other through a dielectric and connected to a power supply such that the porous fiber material and the aerogel powder are subject to the alternating electric field.

Further, in order to better describe the aerogel composite material and the method of manufacturing the aerogel composite material provided by the present invention, the invention provides a plurality of Examples and Contrast Examples to illustrate that the invention has more prominent technical advantages compared with the prior art.

### Example 1

Material: JIOS aerogel Company AeroVa® aerogel powder, particle size: D50<50 μm, density: 0.03-0.1 g/cm³, and porosity >90%.
Owens Corning glass fiber non-woven fabric, gram weight: 125 g/m², thickness: 1.25 mm, and air permeability: 1300~1350 L/m²/s.
High voltage alternating electric field: Consist of two electrodes. One electrode is grounded, and the other electrode is powered by high voltage alternating current. The maximum voltage is ±15 kv, sine wave, and frequency is 600 HZ.
Implementation process: The aerogel powder is evenly spread on the glass fiber non-woven fabric, placed between the high voltage alternating electric fields, and electrified such that that the powder is fully oscillated in it for 2 minutes and will be impregnated into the middle pores of the non-woven fabric.
Results: The final weight ratio of the aerogel powder to the whole material is 42 wt %. FIG. 1 is the SEM photograph of the vertical cross-section of the aerogel composite material in Example 1. It can be seen that the aerogel powder is uniformly impregnated into the pores of the non-woven fabric from the upper surface to the lower surface of the porous fiber material. Due to the large impregnation amount and uniform impregnation of the aerogel powder, the aerogel composite material has good thermal insulation performance.

### Example 2

Material: JIOS aerogel Company AeroVa® aerogel powder, particle size: D50<50 μm, density: 0.03-0.1 g/cm³, porosity >90%; Owens Corning glass fiber non-woven fabric, gram weight: 100 g/m², thickness: 1 mm, and air permeability: 1700~1750 L/m²/s.
High voltage alternating electric field: Consist of two electrodes. One electrode is grounded, and the other electrode is powered by high voltage alternating current. The maximum voltage is ±20 kv, sine wave, and frequency is 600 HZ.
Implementation process: The aerogel powder is evenly spread on the glass fiber non-woven fabric, placed between the high voltage alternating electric fields, and electrified such that that the powder is fully oscillated in it for 2 minutes and will be impregnated into the middle pores of the non-woven fabric.
Results: The final weight ratio of the aerogel powder to the whole material is 32 wt %. FIGS. 2a, 2b, and 2c are respectively SEM photographs of the vertical cross-section, front side, and back side of the aerogel composite material in Example 2.

Compared with FIG. 3a and FIG. 4a of Contrast Examples, it can be seen that the aerogel powder in the aerogel composite material of Example 2 is evenly distributed and the amount of impregnation is relatively large. Compared with FIG. 3b and FIG. 4b of Contrast Examples, it can be seen that the aerogel powder on the front side of the aerogel composite material in Example 2 is evenly distributed and the amount of impregnation is relatively large. From the distribution of the aerogel powder on the back of the aerogel composite material in the Contrast Examples shown in FIG. 3c and FIG. 4c, it can be seen that there is basically no aerogel powder due to insufficient impregnation amount and uneven distribution of the aerogel powder. However, the aerogel powder on the back of the aerogel composite material in Example 2 is evenly distributed, with relatively large impregnation amount.

### Example 3

Material: JIOS aerogel Company AeroVa® aerogel powder, particle size: D50<50 μm, density: 0.03-0.1 g/cm³, porosity >90%; Silicon carbide powder, particle size: 0.5 μm~0.7 μm, density: 0.8~0.9 g/cm³, etc. Owens Corning glass fiber non-woven fabric, gram weight: 100 g/m², thickness: 1 mm, and air permeability: 1700~1750 L/m²/s.
High voltage alternating electric field: Consist of two electrodes. One electrode is grounded, and the other electrode is powered by high voltage alternating current. The maximum voltage is ±20 kv, sine wave, and frequency is 600 HZ.
Implementation process: The aerogel powder and silicon carbide powder are evenly dispersed and spread on the glass fiber non-woven fabric in a ratio of 9:1, placed between high voltage alternating electric fields, and electrified such that the powder is fully oscillated in it for 2 minutes and will be impregnated into the middle pores of the non-woven fabric.
Results: The final weight ratio of the aerogel and silicon carbide powder to the whole material is 41 wt %.

### Example 4

Material: JIOS aerogel Company AeroVa® aerogel powder, particle size: D50<50 μm, density: 0.03-0.1 g/cm³, porosity >90%; Glass fiber and polypropylene fiber blended felt, density: ~90 kg/m³, thickness: ~6 mm, and air permeability: 380~420 L/m²/s.
High voltage alternating electric field: Consist of two electrodes. One electrode is grounded, and the other electrode is powered by high voltage alternating current. The maximum voltage is ±14 kv, sine wave, and frequency is 600 HZ.
Implementation process: The aerogel powder is evenly spread on the glass fiber non-woven fabric, placed between the high voltage alternating electric fields, and electrified such that the powder is fully oscillated in it for 2 minutes and will be impregnated into the middle pores of the non-woven fabric.
Results: The final weight ratio of the aerogel powder to the whole material is 35 wt %.

### Contrast Example 1

Material: JIOS aerogel Company AeroVa® aerogel powder, particle size: D50<50 μm, density: 0.03-0.1 g/cm³, porosity >90%; Owens Corning glass fiber non-woven fabric, gram weight: 125 g/m², thickness: 1.25 mm, and air permeability: 1300~1350 L/m²/s.
Electrostatic spraying: Electrostatic high voltage: 20 KV, electrostatic current: 40 μA, powder pressure: 210 KPa, atomization pressure: 70 KPa, and powder bucket fluidization pressure: 35 KPa.
Implementation process: The non-woven fabric is placed on the horizontal desktop. The electrostatic spraying device is connected to a powder barrel and electrified. The parameters are adjusted. The switch is turned on to evenly coat the aerogel powder on the non-woven fabric, three times in total.
Results: The final weight ratio of the aerogel powder to the whole material is 12 wt %. FIGS. 3a, 3b, and 3c are respectively SEM photographs of the vertical cross-section, front side and back side of the aerogel composite material in Contrast Example 1.

### Contrast Example 2

Material: JIOS aerogel Company AeroVa® aerogel powder, particle size: D50<50 μm, density: 0.03-0.1 g/cm³, porosity >90%; glass fiber and polypropylene fiber blended felt, gram weight: 540 g/m², thickness: 6 mm, and air permeability: 380~420 L/m²/s.
Electrostatic spraying: Electrostatic high voltage: 20 KV, electrostatic current: 40 μA, powder pressure: 210 KPa, atomization pressure: 70 KPa, and powder bucket fluidization pressure: 35 KPa.
Implementation process: the blended felt is placed on the horizontal desktop. The electrostatic spraying device is connected to a powder barrel and electrified. The parameters are adjusted. The switch is turned on to evenly coat the aerogel powder on the non-woven fabric, three times in total.
Results: The final weight ratio of the aerogel powder to the whole material is 8 wt %. FIGS. 4a, 4b, and 4c are respectively SEM photographs of the vertical cross-section, front side and back side of the aerogel composite material in Contrast Example 2.

### Contrast Example 3

Material: JIOS aerogel Company AeroVa® aerogel powder, particle size: D50<50 μm, density: 0.03-0.1 g/cm³, porosity >90%; Owens Corning needle felt, gram weight: 900 g/m², density: 60 kg/m², thickness: ~15 mm, air permeability: 100-300 L/m²/s; and Solvent: ethanol.
Implementation process: The aerogel powder is stirred and dispersed in solvent ethanol to prepare a dispersion liquid with a mass concentration of 10 wt % and a viscosity of 18.1 cP. The dispersion liquid is added to the glass fiber felt, and the negative pressure is pumped to make the dispersion liquid fully impregnated. The glass fiber felt is naturally dried at room temperature for 24 hours, and then put into a 200° C. oven for 12 hours.
Results: The final weight ratio of the aerogel powder to the whole material is 22 wt %. The specific surface area data of aerogel after immersion of the dispersion liquid and drying are shown in Table 1.

### Contrast Example 4

Material: JIOS aerogel Company AeroVa® aerogel powder, particle size: D50<50 μm, density: 0.03-0.1 g/cm³, porosity >90%; Owens Corning needle felt, gram weight: 900 g/m², density: 60 kg/m², thickness: ~15 mm, air permeability: 100-300 L/m²/s; and Solvent: n-hexane.
Implementation process: The aerogel powder is stirred and dispersed in solvent n-hexane to prepare a dispersion liquid with a mass concentration of 10 wt % and a viscosity of 6.24 cP. The dispersion liquid is added to the glass fiber felt, and the negative pressure is pumped to make the dispersion liquid fully impregnated. The glass fiber felt is naturally dried at room temperature for 24 hours, and then put into a 200° C. oven for 12 hours.
Results: The final weight ratio of the aerogel powder to the whole material is 21 wt %. The specific surface area data of aerogel after immersion of the dispersion liquid and drying are shown in Table 1.

### Contrast Example 5

Material: JIOS aerogel Company AeroVa® aerogel powder, particle size: D50<50 μm, density: 0.03-0.1 g/cm³, porosity >90%; Owens Corning glass fiber non-woven fabric, gram weight: ~60 g/m², thickness: ~0.6 mm, air permeability: 3000~3100 L/m²/s; and Solvent: 75% water+25% ethanol.
Implementation process: The aerogel powder is stirred and dispersed in solvent to prepare a dispersion liquid with a mass concentration of 10 wt % and a viscosity of 12.1 cP. The dispersion liquid is added to the glass fiber felt, and the negative pressure is pumped to make the dispersion liquid fully impregnated. The glass fiber felt is naturally dried at room temperature for 24 hours, and then put into a 200° C. oven for 12 hours.
Results: The final weight ratio of the aerogel powder to the whole material is 20 wt %. The specific surface area data of aerogel after immersion of the dispersion liquid and drying are shown in Table 1.

Table 1 shows the pore structure changes of Contrast Examples 3, 4 and 5 after solvent treatment of the aerogel powder. Compared with untreated AeroVa® aerogel powder, the aerogels samples in Contrast Examples 3, 4 and 5 all show a decrease in specific surface area to varying degrees, and the porosity, or pore volume, decreases significantly, indicating that the nanopore in the aerogel powder is damaged in different degrees. The collapse of the inner space of the nanopore causes the pore volume to become smaller and the specific surface area to decrease. The present invention prevents the problem that the structure of the aerogel powder is destroyed by solution treatment due to direct impregnation of the aerogel powder into the porous fiber material through the alternating electric field, such that the aerogel composite material of the invention has better performance.

TABLE 1

| | BET Specific | | Foam |
|---|---|---|---|
| | Surface Area | Porosity | Porosity |
| | (m²/g) | (cm³/g) | Size (nm) |
| AeroVa ® Aerogel Powder | 688 | 3.07 | 16.7 |
| Contrast Example 3 | 654 | 2.83 | 17.3 |
| Contrast Example 4 | 654 | 2.75 | 16.8 |
| Contrast Example 5 | 687 | 2.69 | 14.0 |

The present invention has been described through the above-mentioned embodiments, but it should be understood that the above-mentioned embodiments are only for the purpose of illustration and description, and are not intended to limit the present invention to the scope of the described embodiments. Furthermore, those skilled in the art can understand that the present invention is not limited to the above embodiments, and more variations and modifications can be made according to the teachings of the present invention. These variations and modifications fall within the protection scope claimed by the present invention.

1-12. (canceled)

13. A method of manufacturing an aerogel composite material, wherein the method comprises:
impregnating an aerogel powder into a porous fiber material by applying an alternating electric field, wherein a voltage of the alternating electric field ranges from 0.1 KV to 200 KV; a frequency ranges from 0.1 HZ to 800 HZ; a density of the aerogel powder ranges from 0.01 g/cm³ to 0.5 g/cm³; and an average particle size of the aerogel powder is less than or equal to 500 μm.

14. The method of claim 13, wherein an application time of the alternating electric field ranges from 30 seconds to 5 minutes.

15. The method of claim 13, further comprising at least one of applying the aerogel powder to a surface of the porous fiber material and applying the aerogel powder to a loader that is at least partially subject to the alternating electric field.

16. The method of claim 13, wherein the porous fiber material and the aerogel powder are arranged between a lower electrode and an upper electrode, and the lower electrode and the upper electrode are electrically insulated from each other through a dielectric and connected to a power supply such that the porous fiber material and the aerogel powder are subject to the alternating electric field.

17. The method of claim 13, wherein a density of the aerogel powder ranges from 0.03 g/cm³ to 0.1 g/cm³, and an average particle size of the aerogel powder is less than or equal to 50 μm.

18. The method of claim 13, wherein the porous fiber material is selected from a glass fiber felt, a glass fiber non-woven fabric, a glass fiber textile fabric, a ceramic fiber felt, a paper, a polyurethane fiber felt, a carbon fiber felt, a polypropylene fiber felt, a polypropylene, and a glass fiber composite felt, and a combination of the above.

19. The method of claim 13, wherein the porous fiber material is a glass fiber non-woven fabric, and
wherein an areal density of the glass fiber non-woven fabric is between 20 g/m² and 500 g/m²; a thickness is between 0.3 mm and 4 mm; and an air permeability is between 200 L/m²/s and 3000 L/m²/s.

20. The method of claim 19, wherein an areal density of the glass fiber non-woven fabric is between 50 g/m² and 150 g/m²; a thickness is between 0.5 mm and 1.5 mm; and an air permeability is between 500 L/m²/s and 2000 L/m²/s.

21. The method of claim 20, wherein an areal density of the glass fiber non-woven fabric is between 90 g/m² and 135 g/m²; a thickness is between 0.8 mm and 1.3 mm; and an air permeability is between 1100 L/m²/s and 1800 L/m²/s.

22. The method of claim 13, wherein the porous fiber material is a polypropylene and glass fiber composite felt, and
wherein the polypropylene and glass fiber composite felt is made by blending a polypropylene fiber with a glass fiber; a density of the polypropylene and glass fiber composite felt is between 20 kg/m³ and 200 kg/m³, and a thickness is between 1 mm and 20 mm.

23. The method of claim 22, wherein a density of the polypropylene and glass fiber composite felt is between 50 kg/m³ and 150 kg/m³, and a thickness is between 3 mm and 10 mm.

24. The method of claim 13, wherein an additive for inhibiting thermal radiation is added to the aerogel powder, and the additive is selected from at least one of silicon carbide, boron carbide, titanium oxide and boron nitride; a weight ratio of the additive to the aerogel powder ranges from 1 wt % to 15 wt %.

25. The method of claim 24, a weight ratio of the additive to the aerogel powder ranges from 5 wt % to 12 wt %.
